(19) United States
(12) Patent Application Publication
(10) Pub. No.: US 2024/0339614 A1
(43) Pub. Date: Oct. 10, 2024

(54) METHOD OF MANUFACTURING NEGATIVE ELECTRODE FOR ALL-SOLID-STATE BATTERY USING RUBBER-BASED BINDER

(71) Applicants: Hyundai Motor Company, Seoul (KR); Kia Corporation, Seoul (KR)

(72) Inventors: Byung Yong Lee, Anyang (KR); Hyun Jeong Kim, Suwon (KR)

(21) Appl. No.: 18/236,828

(22) Filed: Aug. 22, 2023

(30) Foreign Application Priority Data
Apr. 7, 2023 (KR) 10-2023-0045771

(51) Int. Cl. H01M 4/62; H01M 4/04; H01M 4/1393; H01M 4/587

(52) U.S. Cl. CPC H01M 4/622; H01M 4/0435; H01M 4/0471; H01M 4/1393; H01M 4/587; H01M 2004/021; H01M 2004/027; H01M 2220/20

(57) ABSTRACT

Proposed is a method of manufacturing a negative electrode for an all-solid-state battery using a rubber-based binder in a dry manner.

### CROSS REFERENCE TO RELATED APPLICATION

The present application claims priority to Korean Patent Application No. 10-2023-0045771, filed Apr. 7, 2023, the entire contents of which is incorporated herein for all purposes by this reference.

### TECHNICAL FIELD

The present disclosure relates to a method of manufacturing a negative electrode for an all-solid-state battery using a rubber-based binder in a dry manner.

### BACKGROUND

When manufacturing electrodes in a dry manner, films are likely to be easily thickened, and the electrode resistance can be reduced, which is advantageous in the implementation of batteries with high energy density.

For example, in conventional methods, polytetrafluoroethylene (PTFE), used as a binder, has been treated as an essential element due to the unique fibrillation thereof.

In polytetrafluoroethylene, the fluorine element takes electrons from the carbon element in the main chain, so the polymer has low highest occupied molecular orbital (HOMO) and lowest unoccupied molecular orbital (LUMO) levels.

The low HOMO level stabilizes the polymer at positive potentials, and polytetrafluoroethylene is thus suitable for a positive electrode.

However, due to the low LUMO level, polytetrafluoroethylene is likely to be degraded in a negative electrode and thus cannot be used as a binder for the negative electrode.

### SUMMARY

In preferred aspects, the disclosure provides a method of manufacturing a negative electrode for an all-solid-state battery using a rubber-based binder in a dry manner.

A term “all-solid-state battery” as used herein refers to a rechargeable secondary battery that includes an electrolyte in a solid state for transferring ions between the electrodes of the battery.

In an aspect, provided is a method of manufacturing a negative electrode for an all-solid-state battery, which may include: preparing a binder solution including a rubber-based binder containing styrene-butadiene rubber (SBR) and a solvent; obtaining an intermediate product including the binder solution and a negative electrode active material that is provided in a powder form; obtaining a complex in which the rubber-based binder is attached to the surface of the negative electrode active material by stirring the intermediate product while evaporating the solvent; and manufacturing a negative electrode by pressing the complex.

The term “binder”, as used herein, refers to a resin or a polymeric material (e.g., synthetic or natural) that can be polymerized or cured to form a polymeric matrix. The binder may be cured (polymerized) or partially cured upon curing process such as heating, UV radiation, electron beaming, chemical polymerization using additives and the like. In certain embodiments, the binder may be a pre-cured form or non-crosslinked form.

The term “styrene-butadiene rubber,” as used herein and understood by an ordinary person skilled in the art, refers to a synthetic rubber material essentially made of styrene units and butadiene units. A ratio of the styrene units and butadiene units may vary to adjust the physical and/or chemical characteristics of the rubber. For example, the ratio of the styrene units and butadiene units may be about 1 to 90:about 99 to 10, about 2 to 90:about 98 to 10, about 10 to 90:about 90 to 10, about 10 to 80:about 90 to 20, about 10 to 70:about 90 to 30, about 10 to 60:about 90 to 40, or about 10 to 50:about 90 to 50.

Preferably, the binder solution may be formed by dissolving the rubber-based binder into the solvent.

The styrene-butadiene rubber may be provided in a non-crosslinked form.

The styrene-butadiene rubber may include an amount of about 10 wt % to 50 wt % of styrene based on the total weight of the styrene-butadiene rubber.

The solvent may include one or more selected from the group consisting of cyclohexane, toluene, xylene, and hexyl butyrate.

The binder solution may include an amount of about 1 wt % to 10 wt % of the rubber-based binder and an amount of about 90 wt % to 99 wt % of the solvent based on the total weight of the binder solution.

The negative electrode active material may include natural graphite, artificial graphite, or combinations thereof.

The negative electrode active material may have an average particle diameter (D50) in a range of about 5 μm to 50 μm.

The intermediate product may further include a conductive material.

In the obtaining of the complex, the intermediate product may be stirred at a temperature in a range of about 40° C. to 80° C. while evaporating the solvent.

Preferably, the complex may be formed by the rubber-based binder binding a first negative electrode active material and a second negative electrode active material that is adjacent to the first negative electrode active material.

The rubber-based binder between the first negative electrode active material and the second negative electrode active material may have a size in a range of about 1 μm to 4 μm.

Before the manufacturing of the negative electrode, the manufacturing method may further include drying the complex in vacuo at a temperature in a range of about 40° C. to 80° C.

Before the manufacturing of the negative electrode, the manufacturing method may further include mixing the complex and a conductive material.

Preferably, the negative electrode may be manufactured by pressing the complex using a rolling mill equipped with a pair of rollers.

A roll speed ratio of the pair of rollers may be equal.

The negative electrode may suitably have a thickness in a range of about 50 μm to 300 μm.

The negative electrode may include about 0.1 wt % to 15 wt % of the rubber-based binder based on the total weight of the negative electrode.

Also, the disclosure provides an all-solid-state battery including the negative electrode manufactured by the methods as described herein.

Further, provided is a vehicle including the all-solid-state battery as described herein.

Other aspects of the invention are disclosed infra.

### BRIEF DESCRIPTION OF THE DRAWINGS

FIG. 1 shows an exemplary method of manufacturing a negative electrode for an exemplary all-solid-state battery according to an exemplary embodiment of the present disclosure;

FIG. 2 shows an exemplary complex according to an exemplary embodiment of the present disclosure;

FIG. 3 shows an exemplary rolling mill used according to an exemplary embodiment of the present disclosure;

FIG. 4 shows a result of observation performed with a scanning electron microscope (SEM) of a negative electrode active material according to an exemplary embodiment of the present disclosure;

FIG. 5 shows an SEM observation result of a complex according to an exemplary embodiment of the present disclosure;

FIG. 6 shows an observation result of a negative electrode with the naked eye according to an exemplary embodiment of the present disclosure;

FIG. 7 shows an SEM observation result for a cross-section of a negative electrode according to an exemplary embodiment of the present disclosure; and

FIG. 8 shows an SEM observation result for a cross-section of a negative electrode according to an exemplary embodiment of the present disclosure, the analysis performed at a scale varying from FIG. 7.

### DETAILED DESCRIPTION

Above objectives, other objectives, features, and advantages of the present disclosure will be readily understood from the following preferred embodiments associated with the accompanying drawings. However, the present disclosure is not limited to the embodiments described herein and may be embodied in other forms. The embodiments described herein are provided so that the disclosure can be made thorough and complete and that the spirit of the present disclosure can be fully conveyed to those skilled in the art. Throughout the drawings, like elements are denoted by like reference numerals.

In the accompanying drawings, the dimensions of the structures are larger than actual sizes for clarity of the present disclosure. Terms used in the specification, “first”, “second”, etc., may be used to describe various components, but the components are not to be construed as being limited to the terms. These terms are used only for the purpose of distinguishing a component from another component. For example, without departing from the scope of the present disclosure, a first component may be referred as a second component, and a second component may be also referred to as a first component.

As used herein, the singular forms “a”, “an”, and “the” are intended to include the plural forms as well unless the context clearly indicates otherwise. It will be further understood that the terms “comprises”, “includes”, or “has” when used in this specification specify the presence of stated features, regions, integers, steps, operations, elements and/or components, but do not preclude the presence or addition of one or more other features, regions, integers, steps, operations, elements, components and/or combinations thereof.

It will also be understood that when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween. Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated. In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

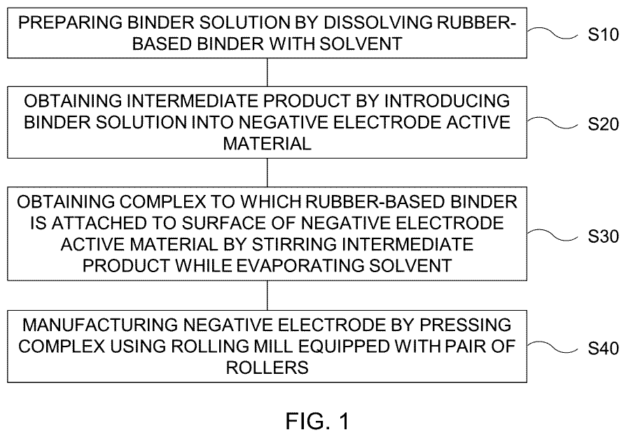

FIG. 1 shows an exemplary method of manufacturing an exemplary negative electrode for an exemplary all-solid-state battery according to an exemplary embodiment of the present disclosure. As shown in FIG. 1, the manufacturing method may include S10 of preparing a binder solution by dissolving a rubber-based binder containing styrene-butadiene rubber (SBR) with a solvent, S20 of obtaining an intermediate product by introducing the binder solution into a negative electrode active material in a powder form, S30 of obtaining a complex in which the rubber-based binder is attached to the surface of the negative electrode active material by stirring the intermediate product while evaporating the solvent, and S40 of manufacturing a negative electrode by pressing the complex using a rolling mill equipped with a pair of rollers.

The rubber-based binder may include styrene-butadiene rubber (SBR). The styrene-butadiene rubber can form a network through a x-interaction (pi-interaction) with the negative electrode active material, and provide flexibility to the negative electrode. In addition, the styrene-butadiene rubber may be stable at a negative electrode potential and thus may not be degraded at the negative electrode, unlike polytetrafluoroethylene. However, due to the amorphous nature of styrene-butadiene rubber, when being mixed in a dry manner, the styrene-butadiene rubber aggregates, so the dispersibility of the resulting mixture is extremely poor. Thus, preferably, after preparing the binder solution in which the styrene-butadiene rubber is dissolved with the solvent, the binder solution may be introduced into a negative electrode material, including the negative electrode active material, to prevent the above problem from occurring.

On the other hand, in the case of existing methods of manufacturing electrodes using polytetrafluoroethylene in a dry manner, intense pressure and shear force are applied to fibrillate binders. However, styrene-butadiene rubber may not be fibrillated and is elastic. For this reason, when a shear force is applied, the styrene-butadiene rubber eventually breaks due to the elasticity thereof. Thus, preferably, a roll speed ratio of the pair of rollers may be set to be equal to apply only pressure to the complex containing the styrene-butadiene rubber and the negative electrode material, including the negative electrode active material, without applying shear force, which is to be described later.

The styrene-butadiene rubber may be provided in a non-crosslinked form. When coating the negative electrode active material with the binder solution, the styrene-butadiene rubber is required to be completely dissolved in the solvent to increase the dispersibility of the styrene-butadiene rubber. In the case of the styrene-butadiene rubber provided in a cross-linked form, the solubility is poor, and the styrene-butadiene rubber thus may fail to be completely dissolved in the solvent.

The styrene-butadiene rubber may include about 10 wt % to 50 wt % of styrene based on the total weight of the styrene-butadiene rubber. When the amount of styrene is less than about 10 wt %, a network formed through a x-interaction with the negative electrode active material may be difficult to be realized. On the contrary, when the amount of styrene is greater than about 50 wt %, rubber properties may be deteriorated, thereby reducing the flexibility of the negative electrode.

The solvent may include a non-polar solvent capable of well-dissolving the styrene-butadiene rubber. In addition, the solvent may be highly volatile. When the volatility of the solvent is low, agglomeration of styrene-butadiene rubber may occur, and evaporation may take longer time. As a result, the complex may be difficult to be obtained.

The solvent may include at least one selected from the group consisting of cyclohexane, toluene, xylene, hexyl butyrate, and combinations thereof.

The binder solution may include an amount of about 1 wt % to 10 wt % of the rubber-based binder and an amount of about 90 wt % to 99 wt % of the solvent based on the total weight of the binder solution. When the amount of the rubber-based binder is less than about 1 wt %, the amount of the solvent may be relatively large. As a result, evaporation may take longer time. On the contrary, when the amount of the rubber-base binder is greater than about 10 wt %, the viscosity of the binder solution may be increased, so the dispersibility of the rubber-based binder may be poor.

The intermediate product may be obtained by introducing the binder solution into the negative electrode active material (S20).

The negative electrode active material may include natural graphite, artificial graphite, or combinations thereof.

The negative electrode active material may have an average particle diameter (D50) in a range of about 5 μm to 50 μm. The average particle diameter may be measured using a currently available laser diffraction/scattering-type particle size distribution measuring device, for example, a micro-track particle size distribution measuring device. In addition, the average particle diameter of two hundreds particles, randomly extracted from electron micrographs, may be calculated.

A method of introducing the binder solution is not particularly limited. For example, the binder solution may be applied on the negative electrode active material in a powder form.

An introduction amount of the binder solution is not particularly limited. The introduction amount of the binder solution may be appropriately adjusted depending on amounts of the rubber-based binder in the negative electrode, which is to be described later.

The intermediate product may further include a conductive material. The binder solution may be introduced into a mixture including the negative electrode active material in the powder form and the conductive material to obtain the intermediate product.

The conductive material may include particulate conductive materials, such as carbon black, graphene, and the like, and/or fibrous conductive materials, such as carbon fibers, carbon nanotubes, vapor-grown carbon fibers (VGCF), and the like.

The complex may be obtained by stirring the intermediate product while evaporating the solvent (S30).

Preferably, a highly volatile solvent may be used in the present disclosure. Thus, the solvent can be quickly volatilized even with simple stirring under mild conditions. Particularly, the intermediate product may be stirred at a temperature in a range of about 40° C. to 80° C. while evaporating the solvent.

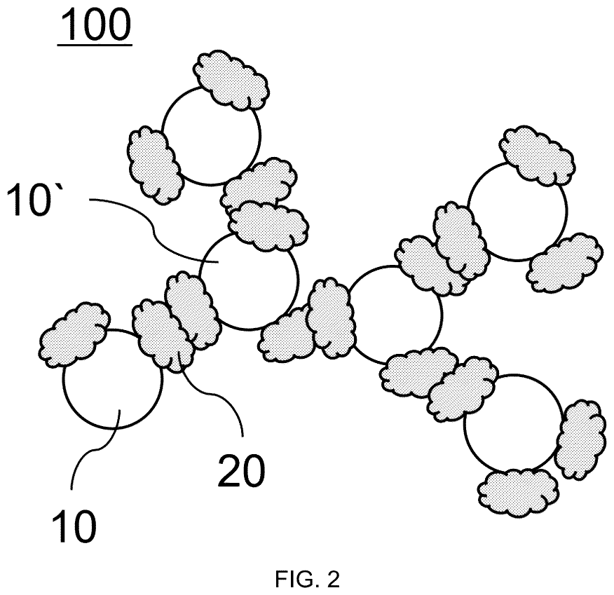

FIG. 2 shows the complex according to an exemplary embodiment of the present disclosure. As shown in FIG. 2, the complex 100 may include the negative electrode active materials 10 and 10′ and the rubber-based binder 20 attached to the surface of the negative electrode active material 10. Specifically, in the complex 100, the rubber-based binder 20 may connect a first negative electrode active material 10 to a second negative electrode active material 10′ adjacent to the first negative electrode active material 10. The rubber-based binder 20 may serve as a kind of bridge. The rubber-based binder 20 may connect the first negative electrode active material 10 and the second negative electrode active material 10′ in a state where the surfaces of the negative electrode active materials 10 and 10′ are not entirely covered. As a result, resistance in the negative electrode may be reduced.

The rubber-based binder 20, interposed between the first negative electrode active material 10 and the second negative electrode active material 10′, may have a size in a range of about 1 μm to 4 μm. The size of the rubber-based binder 20 may mean the width of the rubber-based binder 20 interposed between the negative electrode active materials 10 and 10′. The size of the rubber-based binder 20 may be obtained by measuring the length of contact made by negative electrode active material particles from a result of analysis performed with a scanning electron microscope (SEM) of the complex 100. When the size of the rubber-based binder 20 is less than about 1 μm, the adhesive strength of the complex 100 may decrease. When the size of the rubber-based binder 20 is greater than about 4 μm, the rubber-based binder 20 hinders the movement of lithium ions, thereby deteriorating battery performance.

A ratio of the average particle diameter (D50) of the negative electrode active material to the size of the rubber-based binder 20 may be in a range of about 0.14 to 0.58.

The method of manufacturing the negative electrode for the all-solid-state battery, according to an exemplary embodiment of the present disclosure, may further include drying the complex in vacuo at a temperature in a range of about 40° C. to 80° C. The drying in vacuo is performed to completely volatilize the solvent.

In addition, the method of manufacturing the negative electrode for the all-solid-state battery, according to an exemplary embodiment of the present disclosure, may further include mixing the complex and the conductive material. When the conductive material is not introduced into the intermediate product, the complex may be prepared as described above, and the complex and the conductive material may be then mixed. A method of mixing the complex and the conductive material is not particularly limited, but dry mixing is preferable.

The negative electrode 200 may be prepared by rolling the complex using the rolling mill equipped with the pair of rollers A and A′ (S40).

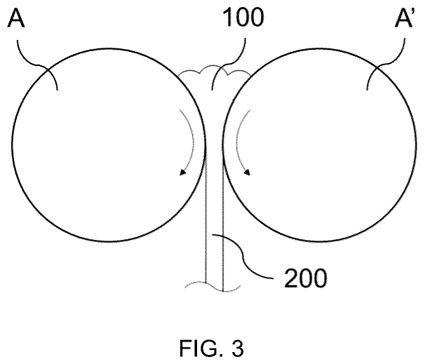

FIG. 3 shows the rolling mill used in the present disclosure. Referring to FIG. 3, the complex 100 may be pressed with the pair of rollers A and A′ to obtain the negative electrode 200 in the form of a self-supporting film.

The pair of rollers A and A′ may suitably rotate in opposite directions.

The pair of rollers A and A′ may be equal in roll speed ratio. In this case, the roll speed ratio may mean a ratio of the rotational speed of a first roller A to the rotational speed of a second roller A′. When the pair of rollers A and A′ differ in roll speed ratio, shear force is applied to the intermediate product 100. Thus, the negative electrode 200 may be torn due to the elasticity of the rubber-based binder.

The negative electrode 200 may have a thickness in a range of about 50 μm to 300 μm.

In addition, the negative electrode 200 may include an amount of about 80 wt % to 99 wt % of the negative electrode active material, an amount of about 0.1 wt % to 5 wt % of the conductive material, and an amount of about 0.1 wt % to 15 wt % of the rubber-based binder, based on the total weight of the negative electrode.

### EXAMPLE

Another embodiment of the present disclosure will be described in more detail through the following example. The following example is only to help the understanding of the present disclosure, and the scope of the present disclosure is not limited thereto.

### Example

Styrene-butadiene rubber (SBR), a rubber-based binder, was dissolved with a solvent to prepare a binder solution. The styrene-butadiene rubber was provided in a non-crosslinked form and contained about 15 wt % of styrene. Xylene was used as the solvent.

The binder solution was applied on artificial graphite, a negative electrode active material, and then stirred at a temperature of about 60° C. while evaporating the solvent. To remove residues of the solvent, the resulting product was dried in vacuo at a temperature of about 60° C. to obtain a complex.

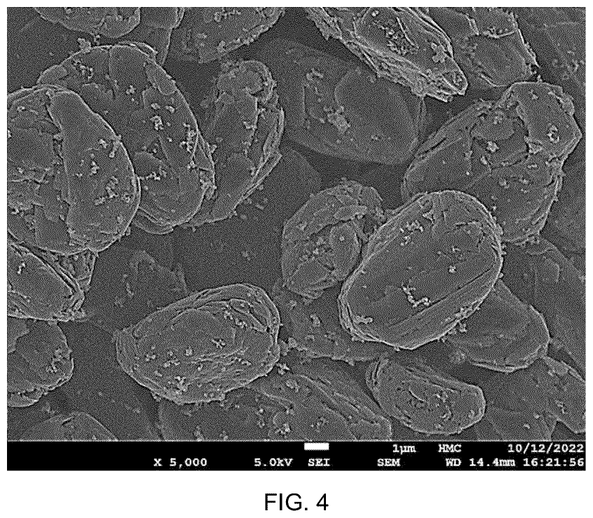

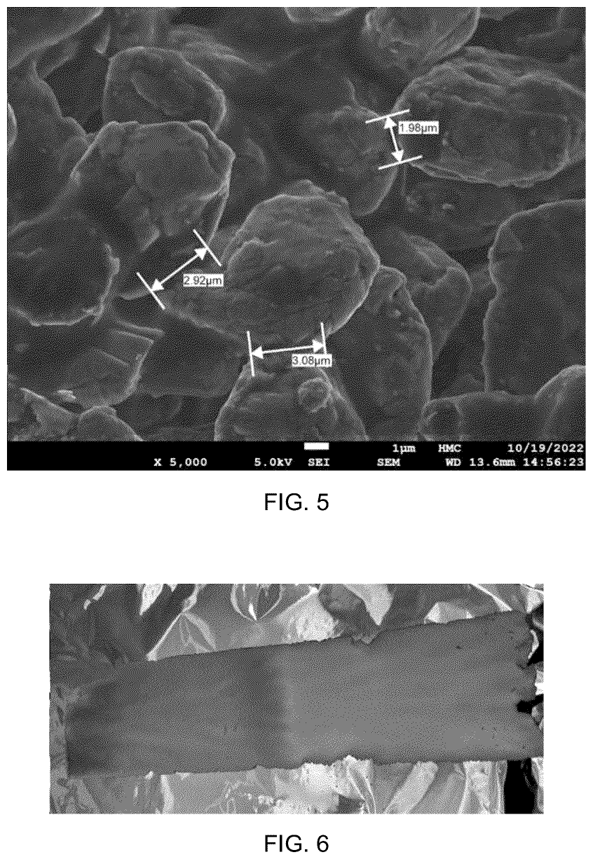

FIG. 4 shows a result of observation performed with a scanning electron microscope (SEM) of the negative electrode active material. FIG. 5 shows an SEM observation result of the complex. As shown in FIGS. 4 and 5, the styrene-butadiene rubber was attached to the surface of the negative electrode active material, thereby connecting negative electrode active material particles to each other. In addition, the styrene-butadiene rubber, positioned between the negative electrode active material particles, had a size in a range of about 1 μm to 4 μm.

A conductive material was introduced into the complex, and then a dry mixing was performed to obtain a powder mixture. The amount of each component was adjusted so that the powder mixture contained 97 wt % of the negative electrode active material, 1 wt % of the conductive material, and 2 wt % of the rubber-based binder.

The powder mixture was introduced into a two-roll rolling mill, and the respective roll speed ratios were set to be equal to manufacture a negative electrode.

FIG. 6 shows an observation result of the negative electrode with the naked eye. When applying the binder solution, in which the styrene-butadiene rubber dissolved, on the negative electrode active material to attach the styrene-butadiene rubber to the negative electrode active material, and then performing film formation on the resulting product using the rolling mill, in which the roll speed ratios were equal with the equal roll speed ratio as described in the present disclosure, the negative electrode could be manufactured without breaking.

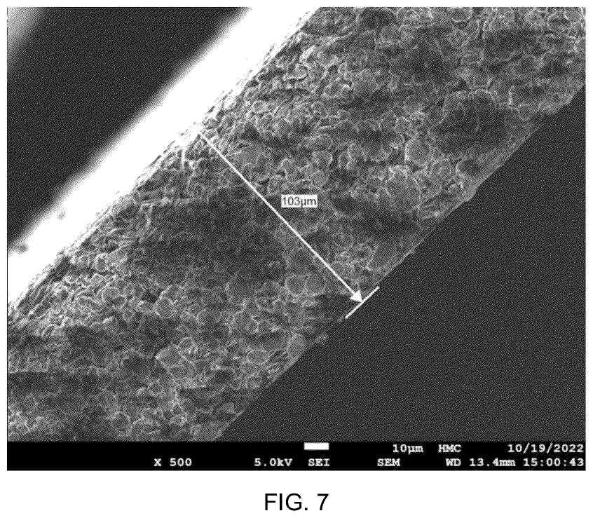

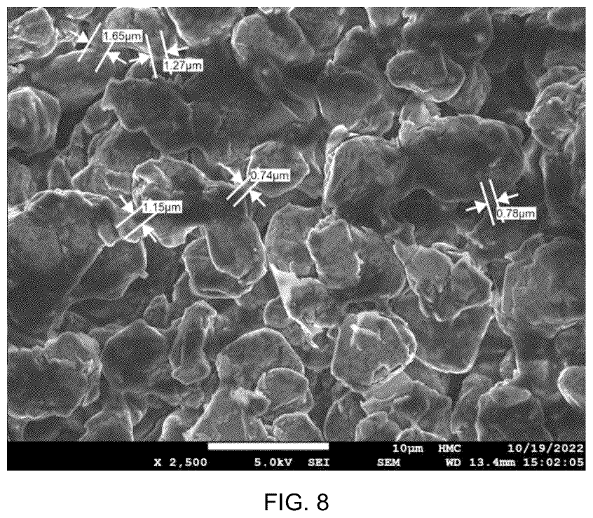

FIG. 7 shows an SEM observation result for a cross-section of the negative electrode. FIG. 8 shows an SEM analysis result for a cross-section of the negative electrode at a scale varying from FIG. 7. As shown in FIGS. 7 and 8, the negative electrode has a thickness of about 100 μm, and the negative electrode active materials were well connected to each other through the styrene-butadiene rubber.

While the present disclosure has been particularly shown and described with reference to various exemplary embodiments thereof, it is to be understood that the scope of the present disclosure is not limited to the disclosed exemplary embodiments. Modified forms are also included within the scope of the present disclosure.

What is claimed is:

1. A method of manufacturing a negative electrode for an all-solid-state battery, comprising:
preparing a binder solution comprising a rubber-based binder comprising styrene-butadiene rubber and a solvent;
obtaining an intermediate product comprising the binder solution and a negative electrode active material that is provided in a powder form;
obtaining a complex in which the rubber-based binder is attached to the surface of the negative electrode active material; and
manufacturing a negative electrode by pressing the complex.

2. The method of claim 1, wherein the styrene-butadiene rubber is provided in a non-crosslinked form.

3. The method of claim 1, wherein the styrene-butadiene rubber comprises an amount of about 10 wt % to 50 wt % of styrene based on the total weight of the styrene-butadiene rubber.

4. The method of claim 1, wherein the solvent comprises one or more selected from the group consisting of cyclohexane, toluene, xylene, and hexyl butyrate

5. The method of claim 1, wherein the binder solution comprises an amount of about 1 wt % to 10 wt % of the rubber-based binder and an amount of about 90 wt % to 99 wt % of the solvent, based on the total weight of the binder solution.

6. The method of claim 1, wherein the negative electrode active material comprises natural graphite, artificial graphite, or combinations thereof.

7. The method of claim 1, wherein the negative electrode active material has an average particle diameter (D50) in a range of about 5 μm to 50 μm.

8. The method of claim 1, wherein the intermediate product further comprises a conductive material.

9. The method of claim 1, wherein in the obtaining of the complex, the intermediate product is stirred while evaporating the solvent.

10. The method of claim 1, wherein in the obtaining of the complex, the intermediate product is stirred at a temperature in a range of about 40° C. to 80° C. while evaporating the solvent.

11. The method of claim 1, wherein the complex is formed by the rubber-based binder binding a first negative electrode active material and a second negative electrode active material adjacent thereto.

12. The method of claim 11, wherein the rubber-based binder between the first negative electrode active material and the second negative electrode active material has a size in a range of about 1 μm to 4 μm.

13. The method of claim 1, further comprising drying the complex in vacuo at a temperature in a range of about 40° C. to 80° C. before the manufacturing of the negative electrode.

14. The method of claim 1, further comprising mixing the complex and a conductive material before the manufacturing of the negative electrode.

15. The method of claim 1, wherein the negative electrode is manufactured by pressing the complex using a rolling mill equipped with a pair of rollers.

16. The method of claim 15, wherein a roll speed ratio of the pair of rollers is equal.

17. The method of claim 1, wherein the negative electrode has a thickness in a range of 50 μm to 300 μm.

18. The method of claim 1, wherein the negative electrode comprises an amount of about 0.1 wt % to 15 wt % of the rubber-based binder based on the total weight of the negative electrode.

19. An all-solid-state battery comprising a negative electrode manufactured by a method of claim 1.

20. A vehicle comprising an all-solid-state battery of claim 19.
